(19) United States
(12) Patent Application Publication
(10) Pub. No.: US 2003/0038484 A1
(43) Pub. Date: Feb. 27, 2003

(54) Vehicle closure member latch assembly having actuator stop

(76) Inventors: Dennis D. Schwaiger, Whitmore Lake, MI (US); Curt D. Campbell, Farmington Hills, MI (US)

Correspondence Address: James A. Kushman, Brook & Kushman P.C., 22nd Floor, 1000 Town Center, Southfield, MI, 48075-1351, US

(21) Appl. No.: 10/223,948

(22) Filed: Aug. 20, 2002

Related U.S. Application Data
(60) Provisional application No. 60/314,192, filed on Aug. 22, 2001.

(51) Int. Cl. E05C 3/06

(52) U.S. Cl. 292/201

(57) ABSTRACT

A vehicle latch assembly (16) has a catch (24) released by a pawl (32) upon actuation of a release member (40) by operation of an electric motor worm gear drive (54). A drive portion (62) of an output gear (60) of the worm gear drive (54) is cyclically positioned in a start position thereof by a positioning member (66) by movement thereof between start and blocking positions thereof in response to the movement of the pawl (32) upon releasing the catch (24).

### CROSS-REFERENCE TO RELATED APPLICATIONS

This application claims the benefit of U.S. provisional application Serial No. 60/314,192 filed Aug. 22, 2001.

### BACKGROUND OF THE INVENTION

1. Field of the Invention

This invention relates to a vehicle closure member latch assembly for holding a closure member in a closed position with respect to a vehicle body opening and being selectively actuatable to release the closure member for opening.

2. Background Art

Vehicle closure members conventionally include a latch assembly for selectively securing a striker to hold the closure member in a closed position with respect to an access opening of an associated vehicle body. For example, vehicle deck lids for which the latch assembly of the present invention has particular utility are conventionally counterbalanced to an open position by torque rods and are selectively held in the closed position by the cooperation of a latch assembly and an associated striker. Normally the striker is mounted on the vehicle body and the latch assembly is mounted on the vehicle deck lid; however, the reverse mounting is also sometimes used with the striker mounted on the vehicle deck lid and the latch assembly mounted on the vehicle body. Upon unlatching of the striker by the latch assembly, the counterbalancing provided by the torque rods moves the closure member to an open position with or without manual assistance. However, in some instances ice or snow that accumulates can prevent the opening movement of the closure member. When the unlatching of the latch assembly is provided by an electric motor drive release, this condition can result in continual electric motor driving of the drive release until the closure member is moved to its open position whereupon an associated catch of the latch assembly moves to an unlatched position in a manner that terminates the electric motor driving through the accompanying movement of the latch assembly components.

Prior art patents noted during an investigation conducted in connection with the present invention includes U.S. Pat. Nos. 5,074,603 Brackmann; 5,137,311 Brackmann-Horst; 5,938,253 Szablweski et al.; 6,109,671 Roncin et al; 6,264,253 Takaishi; and 6,267,420 Miyagawa.

### SUMMARY OF THE INVENTION

An object of the present invention is to provide an improved vehicle latch assembly for holding a vehicle closure member in a closed position with respect to a vehicle body opening defined by a vehicle body member, and with the latch assembly being actuatable to permit movement of the closure member from the closed position to an open position so as to allow access through the vehicle opening.

In carrying out the above object, the latch assembly of the invention includes a housing mountable on one of the members. A catch of the latch assembly is pivotally mounted on the housing for movement between: a latched position for securing a striker mounted on the other member to hold the closure member in the closed position with respect to the vehicle body opening, and an unlatched position that releases the striker and permits the closure member to move from the closed position to the open position. A pawl is pivotally mounted on the housing for movement between: a blocking position where the pawl engages the catch to hold the catch in its latched position and thereby maintain the closure member in the closed position, and a released position where the pawl is disengaged from the catch to permit movement of the catch to its unlatched position and thereby permit movement of the closure member from the closed position to the open position. A release member of the latch assembly is mounted on the housing for movement from a start position to a released position to move the pawl from its blocking position to its released position to permit movement of the catch from its latched position to its unlatched position. An actuator of the latch assembly includes an electric motor worm gear drive having a rotary output gear that has a drive portion for moving the release member from its start position to its released position. A positioning member of the latch assembly is mounted on the housing and moved from a start position to a blocking position when the pawl is moved from its blocking position to its release position with respect to the catch. The positioning member has a blocking portion that engages the drive portion of the output gear to position the output gear in a start position thereof in preparation for another cycle for actuating the release member for movement from its start position to its release position.

The positioning member of the latch assembly includes a first arm having a distal end that embodies the blocking portion of the positioning member, and the positioning member also has a second arm. A spring extends between the catch and the second arm of the positioning member to bias the catch toward its unlatched position and to bias the positioning member toward its start position. Another spring biases the release member toward its start position.

The latch assembly also includes a sensor that senses the location of the release member and further includes another sensor that senses the location of the positioning member.

Thus, the construction of the latch assembly has: the positioning member including a first arm having a distal end that embodies the blocking portion of the positioning member, the positioning member also having a second arm, a first spring that extends between the catch and the second arm of the positioning member to bias the catch toward its unlatched position and to bias the positioning member toward its start position, a spring that biases the release member toward its start position, a first sensor that senses the location of the release member, and a second sensor that senses the location of the positioning member.

The actuator also includes a key nut that selectively moves the release member from its start position to its released position. This key nut includes an actuating portion, and the release member has an opening that receives the actuating portion of the key nut and has a cam surface that is moved by the actuating portion of the key nut to move the release member from its start position to its release position.

In addition, the actuator is disclosed as including a remote cable release that is connected to the release member and is selectively actuatable to move the release member from its start position to its released position.

### BRIEF DESCRIPTION OF THE DRAWINGS

FIG. 1 is a side elevational view of a vehicle having a latch assembly constructed in accordance with the invention to hold a closure member, such as the rear deck lid shown, in a closed position shown by a solid line representation and to selectively permit movement thereof to an open position shown by phantom line representation.

FIG. 2 is a view of the latch assembly which is shown in a latched position holding a striker so as to maintain the closure member in its closed position.

FIG. 3 is a view that illustrates the latch assembly after actuation thereof to commence unlatching of the latch assembly.

FIG. 4 is a view that illustrates the latch assembly at a further stage of its unlatching after a striker has been released by a catch to permit opening movement of the closure member.

FIG. 5 is a view illustrating the latch assembly after it has been actuated to permit the catch to move to its unlatched position but without any such movement because the closure member is prohibited from such movement such as by accumulated ice or snow.

FIG. 6 is a view illustrating the manner in which the latch assembly is released by key nut operation.

FIG. 7 is a view of another embodiment of the latch assembly which includes a remote cable release for providing the unlatching.

FIG. 8 is a view that illustrates the remote cable release embodiment of the latch assembly after its catch has been unlatched.

### DETAILED DESCRIPTION OF THE PREFERRED EMBODIMENTS

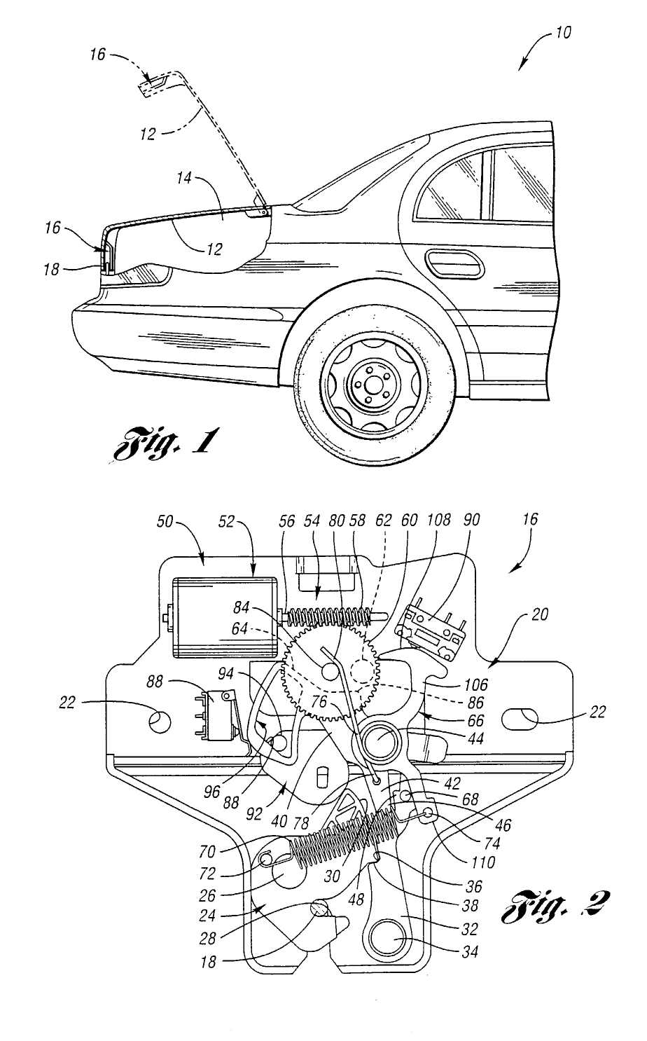

With reference to FIG. 1, a vehicle generally indicated by 10 is disclosed as including a closure member that is embodied by a rear deck lid 12 that is movable between a solid line indicated closed position and a phantom line indicated open position to permit access through a vehicle opening 14 into the associated vehicle trunk storage compartment. A latch assembly 16 constructed in accordance with the invention is illustrated as being mounted on the deck lid 12 and as cooperating with a vehicle body mounted striker 18 to hold the deck lid in its closed position and selectively permit movement thereof to its open position by actuation of the latch assembly 16 to release the striker 18 as is hereinafter more fully described. It should be appreciated that the latch assembly 16 is conventionally mounted on the closure member provided by the deck lid 12 and the striker 18 is mounted on a vehicle body member adjacent the rear of the vehicle storage compartment trunk, but the relative position can also be reversed so that the latch assembly is on the vehicle body and the striker is on the deck lid.

With reference to FIG. 2, the latch assembly 16 includes a housing 20 having fastener openings 22 for receiving suitable fasteners such as threaded studs or bolts utilized to mount the latch assembly by threaded connections. A catch 24 of the latch assembly is pivotally mounted by a pin 26 on the housing 20 for movement between a latched position shown in FIG. 2 and a released position as shown in FIG. 4. The catch 22 has a throat 28 that receives the striker 18 in its latched position of FIG. 2 so as to secure the associated deck lid closure member in its closed position. In its released position shown in FIG. 4, the catch throat 28 releases the striker 18 to permit movement of the deck lid closure member to its open position in order to permit access through the vehicle opening. Subsequent closing of the closure member causes the striker to pivot the catch 24 back to its latched position for latching as is hereinafter more fully described. The catch 24 also has a pawl engagement portion 30 whose operation is subsequently described in connection with FIG. 4.

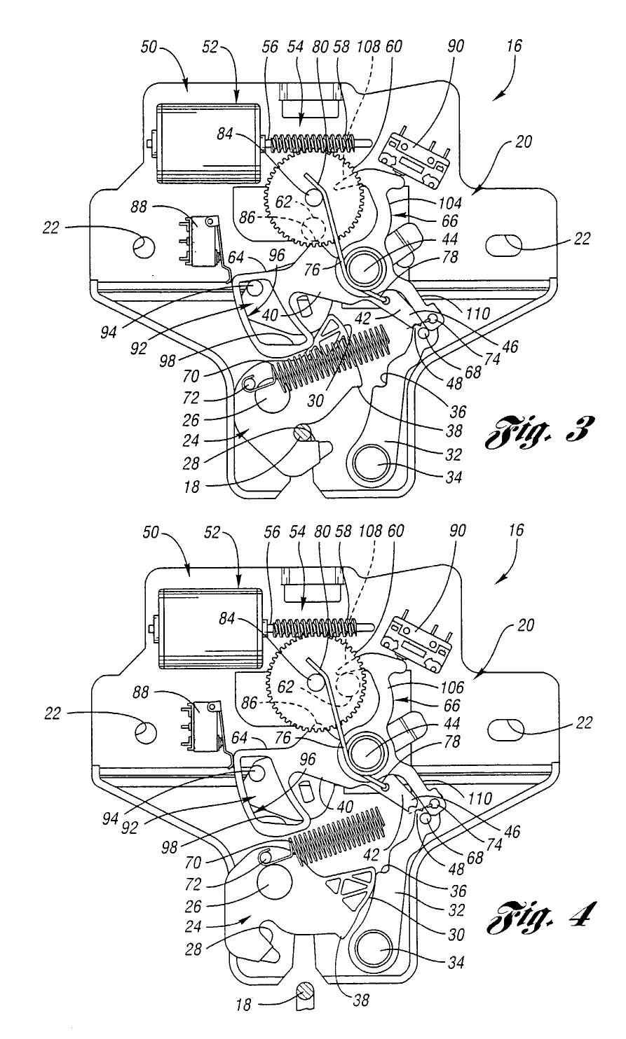

As shown in FIG. 2, the latch assembly 16 also includes a pawl 32 pivotally mounted by a pin 34 on the housing 20 for movement between the blocking position illustrated and a released position as shown in FIG. 3. In the blocking position of FIG. 2, a blocking notch 36 of the pawl receives and engages a lobe 38 of the catch 24 to hold the catch in its latched position and thereby maintain the deck lid closure member in the closed position. In the release position of FIG. 3, the pawl 32 has its notch 36 disengaged from the catch 24 at its lobe 38 to permit movement of the catch to its unlatched position shown in FIG. 4 so that the striker 18 is released to permit movement of the deck lid closure member from the closed position to the open position.

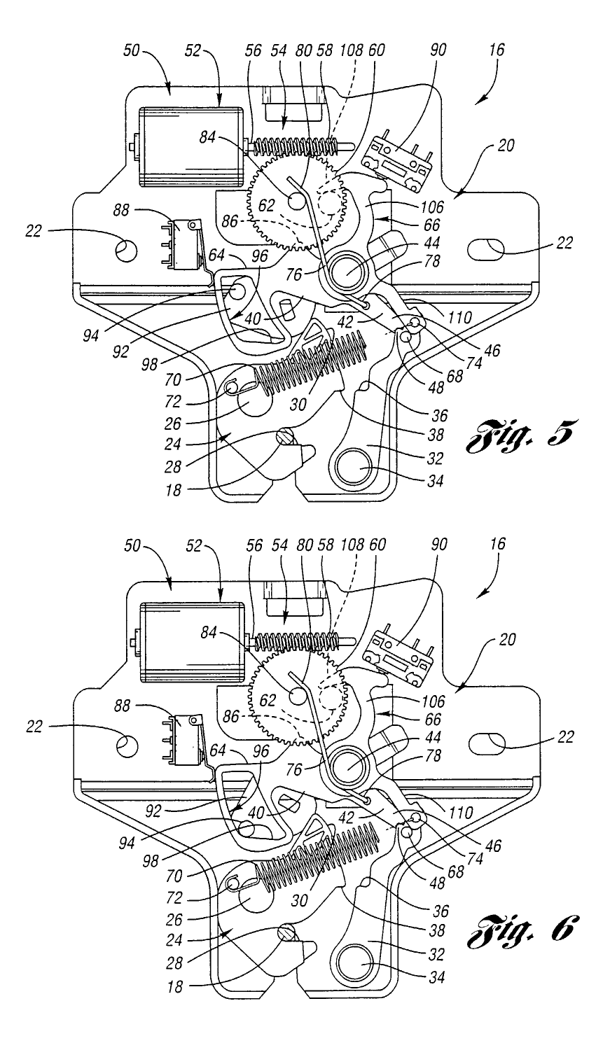

A release member 40 of the latch assembly has an actuating portion 42 and is pivotally mounted by a pin 44 on the housing 20 for actuatable movement from a start position shown in FIG. 2 to a released position shown in FIG. 3. When the release member 40 is in its start position shown in FIG. 2, the catch 24 is held in the latched position by the pawl 32 in its blocking position as previously described. The actuating movement as is hereinafter more fully described moves the release member 40 to its released position of FIG. 3 where the actuating portion 42 of the release member engages and moves the pawl 32 to its released position to permit movement of the catch 24 to its unlatched position. Under normal circumstances, the catch 24 then pivots to its unlatched position of FIG. 4 as the striker 18 is released as shown in FIG. 4 and the pawl engagement portion 30 of the catch then pivots the pawl 32 clockwise and releases the actuating portion 42 of the release member 40 to permit release member movement back to its start position under a spring bias that is hereinafter described. However, when the closure member is not free to open such that the striker 18 does not move relative to the catch 24 as shown in FIG. 5 even though the pawl 32 has released the catch, a notched distal end 46 of the actuating portion 42 of release member 40 engages a lobe 48 of the pawl 32 to maintain the pawl in its released position such that the latch does not again latch and prevent opening of the closure member once the ice, snow or other accumulation etc. is removed to permit opening of the closure member.

An actuator collectively indicated by 50 is actuatable to move the release member from its start position of FIG. 2 to its released position of FIG. 3 in order to provide the pawl member movement from its blocking position to its release position for unlatching of the latch assembly. This actuator is mounted on the housing 20 and includes an electric motor 52 and worm gear drive 54 that is driven by the electric motor to provide the movement of the release member. More specifically, the electric motor 52 has a rotary output 56 that rotatively drives a worm gear 58 of the worm gear drive 54 which also includes a rotary output gear 60. This output gear 60 has a drive portion 62, and the release member 40 has a driven surface 64 that is engaged by the drive portion of the output gear 60 upon rotary driving thereof provided by the electric motor so that the release member moves from its start position of FIG. 1 to its released position illustrated in FIG. 5.

As illustrated in FIG. 2, the latch assembly 16 includes a positioning member 66 that is pivotally mounted on the housing 20 by the same pin 44 that pivotally mounts the release member 40. More specifically, this positioning member 66 is mounted for movement from the start position shown in FIG. 2 to a blocking position illustrated in FIG. 4, this movement being provided by a pin 68 on the pawl when the pawl is moved from its blocking position to its released position with respect to the catch 24. In the blocking position as illustrated in FIG. 4, the positioning member 66 engages the drive portion 62 of the output gear 60 of worm gear drive 54 to position the output gear in preparation for the next releasing actuation cycle.

As shown in FIG. 2, the latch assembly includes a spring 70 having one end secured to a pin 72 on the catch 24 and having another end secured in an opening 74 of the positioning member 66. This spring 70 biases the catch 24 to its released position of FIG. 4 and in addition biases the positioning member 66 to its start position of FIG. 2. Furthermore, engagement of the positioning member 66 with the pin 68 on the pawl also biases the pawl toward its blocking position shown in FIG. 2.

Latch assembly 16 as shown in FIG. 2 includes another spring 76 that is wound around the pin 44 and has an arm 78 extending to the release member 40 and another arm 80 extending to a shaft 84 about which the output gear 60 rotates. This spring 76 biases the release member 40 to its start position of FIG. 2. Thus, the actuating movement of the release member 40 by the electric motor driven worm gear drive 54 is against the bias of the spring 76 which thus provides pressure between the drive portion 62 of the output gear 60 and the driven surface 64 of the release member 40. Likewise, the spring 70 exerts a clockwise bias on the positioning member 66 which in turn biases the pin 68 on pawl 32 in a counterclockwise direction and in turn biases the actuating portion 42 of the release member 40 so as to also resist the actuating movement of the worm gear drive. Furthermore, it will be noted that after the output gear 60 has rotated sufficiently far to provide the latch release operation, its drive portion 62 passes over a lobe 86 of the driven surface 64 in preparation for moving back to its start position and to then also permit the release member to move back to its start position when permitted to do so by the unlatching of the latch. As previously mentioned, the positioning member 66 will then be moved to its blocking position of FIG. 5 so as to limit the rotation of the output gear 60 and position the drive portion 62 against further movement. Normally, the electric motor 62 will be electrically energized with a power duration sufficient to provide the rotary movement to the start position without maintaining the electrical supply to the motor so that it over heats after the rotation is blocked by the positioning member 66.

A sensor 88 senses the position of the release member 40 and functions to provide an alarm reset. Furthermore, a sensor 90 senses the position of the positioning member 66 to provide a closure member ajar signal.

The latch actuator also includes a key nut 92 that is rotatively moved by a key operated lock cylinder that is not shown. This key nut 92 as shown in FIG. 2 includes an actuator portion 94, and the release member 40 has an opening 96 that received the actuating portion 94 of the key nut. More specifically, the release member opening 96 has a cam surface 98 that is moved by the actuating portion 94 of the key nut 92 to move the release member from its start position shown in FIG. 5 to its released position shown in FIG. 6.

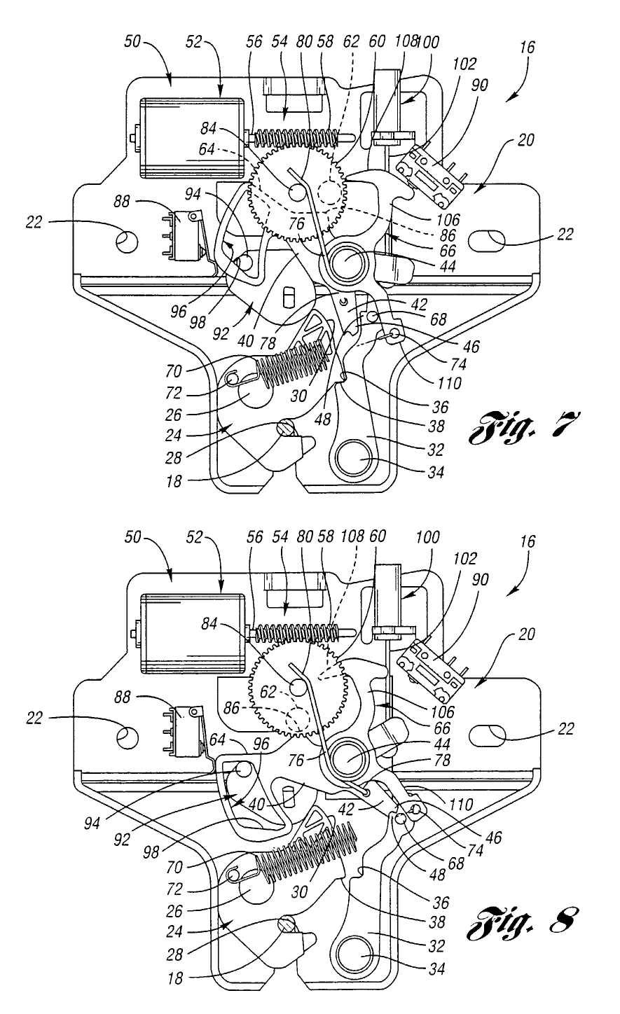

As shown in FIGS. 7 and 8, the latch assembly 16 also includes a remote cable release 100 that has a cable 102 connected to an arm 104 of the release member 40 such that pulling of the cable rotates the release member counterclockwise about the pin 44 for movement from its start position of FIG. 7 to its release position of FIG. 8.

Normally the latch assembly will have the electric motor driven worm gear drive release 54 to permit unlatching of the latch assembly by a vehicle occupant compartment actuation button, as well as having the key nut 92 for permitting exterior key release actuation of the latch assembly, and the remote cable release 100 will permit release of the latch assembly from within the trunk storage compartment as now required by certain governmental regulations.

It will be noted in FIG. 2 that the construction of the positioning member 66 includes a first arm 106 having a blocking portion 108 which moves into the path of the output gear drive portion 62 as the release member 40 is moved to its FIG. 3 release position in order to provide the positioning the output gear as previously described. A second arm 110 extends from the pin 44 that pivotally mounts the positioning member 66 and includes the hole 44 that connected to the adjacent end of the spring 70 that provides the biasing of the catch 24 to its released position and the biasing of the positioning member 66 to its start position as well as the biasing of the pawl 32 to its blocking position through the engagement of the arm 110 with the pin 66.

While the preferred embodiments for carrying out the invention have been described in detail, those familiar with the art to which this invention relates will recognize various alternative designs and embodiments for carrying out the invention as described by the following claims.

What is claimed is:

1. A vehicle latch assembly for holding a closure member in a closed position with respect to a vehicle opening defined by a vehicle body member, and the latch assembly being actuatable to permit movement of the closure member from the closed position to an open position so as to allow access through the vehicle opening, the latch assembly comprising:
a housing mountable on one of the members;
a catch pivotally mounted on the housing for movement between: a latched position for securing a striker mounted on the other member to hold the closure member in the closed position with respect to the vehicle opening, and an unlatched position that releases the striker and permits the closure member to move from the closed position to the open position;
a pawl pivotally mounted on the housing for movement between: a blocking position where the pawl engages the catch to hold the catch in its latched position and thereby maintain the closure member in the closed position, and a released position where the pawl is disengaged from the catch to permit movement of the catch to its unlatched position and thereby permit movement of the closure member from the closed position to the open position;
a release member mounted on the housing for movement from a start position to a released position to move the pawl from its blocking position to its released position to permit movement of the catch from its latched position to its unlatched position;
an actuator including an electric motor worm gear drive having a rotary output gear that has a drive portion for moving the release member from its start position to its released position; and
a positioning member that is mounted on the housing and moved from a start position to a blocking position when the pawl is moved from its blocking position to its released position with respect to the catch, and the positioning member having a blocking portion that engages the drive portion of the output gear to position the output gear in its start position in preparation for another cycle for actuating the release member for movement from its start position to its released position.

2. A latch assembly as in claim 1 wherein the positioning member includes a first arm having a distal end that embodies the blocking portion of the positioning member, the positioning member also having a second arm, and a spring that extends between the catch and the second arm of the positioning member to bias the catch toward its unlatched position and to bias the positioning member toward its start position.

3. A latch assembly as in claim 2 further including another spring that biases the release member toward its start position.

4. A latch assembly as in claim 1 further including a sensor that senses the location of the release member.

5. A latch assembly as in claim 1 further including a sensor that senses the location of the positioning member.

6. A latch assembly as in claim 1 including: a first sensor that senses the location of the release member, and a second sensor that senses the location of the positioning member.

7. A latch assembly as in claim 1 wherein the positioning member includes a first arm having a distal end that embodies the blocking portion of the positioning member, the positioning member also having a second arm, a first spring that extends between the catch and the second arm of the positioning member to bias the catch toward its unlatched position and to bias the positioning member toward its start position, a second spring that biases the release member toward its start position, a first sensor that senses the location of the release member, and a second sensor that senses the location of the positioning member.

8. A latch assembly as in claim 1 wherein the actuator includes a key nut that selectively moves the release member from its start position to its released position.

9. A latch assembly as in claim 8 wherein the key nut includes an actuating portion, and the release member having an opening that receives the actuating portion of the key nut and has a cam surface that is moved by the actuating portion of the key nut to move the release member from its start position to its released position.

10. A latch assembly as in claim 1 wherein the actuator includes a remote cable release that is connected to the release member and is selectively actuatable to move the release member from its start position to its released position.

11. A vehicle latch assembly for holding a closure member in a closed position with respect to a vehicle opening defined by a vehicle body member, and the latch assembly being actuatable to permit movement of the closure member from the closed position to an open position so as to allow access through the vehicle opening, the latch assembly comprising:
a housing mountable on one of the members;
a catch pivotally mounted on the housing for movement between: a latched position for securing a striker mounted on the other member to hold the closure member in the closed position with respect to the vehicle opening, and an unlatched position that releases the striker and permits the closure member to move from the closed position to the open position;
a pawl pivotally mounted on the housing for movement between: a blocking position where the pawl engages the catch to hold the catch in its latched position and thereby maintain the closure member in the closed position, and a released position where the pawl is disengaged from the catch to permit movement of the catch to its unlatched position and thereby permit movement of the closure member from the closed position to the open position;
a release member mounted on the housing for movement from a start position to a released position to move the pawl from its blocking position to its released position to permit movement of the catch from its latched position to its unlatched position;
an actuator including an electric motor worm gear drive having a rotary output gear that has a drive portion for moving the release member from its start position to its released position;
a positioning member that is mounted on the housing and moved from a start position to a blocking position when the pawl is moved from its blocking position to its released position with respect to the catch, the positioning member having first and second arms, and the first arm of the positioning member having a distal end including a blocking portion that engages the drive portion of the output gear to position the output gear in its start position in preparation for another cycle for actuating the release member for movement from its start position to its released position; and
a spring that extends between the catch and the second arm of the positioning member to bias the catch toward its unlatched position and to bias the positioning member toward its start position.

12. A vehicle latch assembly for holding a closure member in a closed position with respect to a vehicle opening defined by a vehicle body member, and the latch assembly being actuatable to permit movement of the closure member from the closed position to an open position so as to allow access through the vehicle opening, the latch assembly comprising:
a housing mountable on one of the members;
a catch pivotally mounted on the housing for movement between: a latched position for securing a striker mounted on the other member to hold the closure member in the closed position with respect to the vehicle opening, and an unlatched position that releases the striker and permits the closure member to move from the closed position to the open position;
a pawl pivotally mounted on the housing for movement between: a blocking position where the pawl engages the catch to hold the catch in its latched position and thereby maintain the closure member in the closed position, and a released position where the pawl is disengaged from the catch to permit movement of the catch to its unlatched position and thereby permit movement of the closure member from the closed position to the open position;
a release member mounted on the housing for movement from a start position to a released position to move the pawl from its blocking position to its released position to permit movement of the catch from its latched position to its unlatched position;
an actuator including an electric motor worm gear drive having a rotary output gear that has a drive portion for moving the release member from its start position to its released position, and the actuator also including a key nut and a remote cable release that each selectively moves the release member to move the release member from its start position to its released position to provide the pawl movement from its blocking position to its released position;
a positioning member that is mounted on the housing and moved from a start position to a blocking position when the pawl is moved from its blocking position to its released position with respect to the catch, the positioning member having first and second arms, and the first arm of the positioning member having a distal end including a blocking portion that engages the drive portion of the output gear to position the output gear in its start position in preparation for another cycle for actuating the release member for movement from its start position to its released position;
a first spring that extends between the catch and the second arm of the positioning member to bias the catch toward its unlatched position and to bias the positioning member toward its start position;
a second spring that biases the release member toward its start position;
a first sensor that senses the location of the release member; and
a second sensor that senses the location of the positioning member.
